(19) United States
(12) Patent Application Publication
(10) Pub. No.: US 2023/0385822 A1
(43) Pub. Date: Nov. 30, 2023

(54) METHOD AND SYSTEM FOR PROCESSING AN ASSET SWAP ACROSS TWO BLOCKCHAINS

(71) Applicant: MASTERCARD INTERNATIONAL INCORPORATED, Purchase, NY (US)

(72) Inventors: Saravana Perumal SHANMUGAM, Fremont, CA (US); Rajasekaran DHAMODHARAN, San Carlos, CA (US); Arnab MAITY, South Plainfield, NJ (US); Mohammed Sadiq AHMAD, Dublin, CA (US)

(73) Assignee: MASTERCARD INTERNATIONAL INCORPORATED, Purchase, NY (US)

(21) Appl. No.: 17/752,318

(22) Filed: May 24, 2022

(51) Int. Cl. G06Q 20/40; G06Q 20/36

(52) U.S. Cl. CPC G06Q 20/401; G06Q 20/36; G06Q 2220/00

(57) ABSTRACT

A swap check oracle receives a transfer request from a user or smart contract on a first blockchain indicating a first digital asset to be transferred. The swap check oracle verifies the authenticity of the user and/or digital asset and instructs the smart contract to transfer the first digital asset to a custodial blockchain address on the first blockchain. Another swap check oracle performs the same process for a second digital asset from a second user on a second blockchain. A central processing server is notified of the successful transfer of the digital assets to the custodial addresses on both blockchains, verifies the holding of the digital assets by the custodial addresses, and then initiates a release of the digital assets to the new parties on both of the blockchains.

### FIELD

The present disclosure relates to processing an asset swap across two blockchains, specifically the use of swap check oracles, a central processing server, and custodied wallet addresses to ensure secure and verifiable cross-chain asset swaps.

### BACKGROUND

Blockchains have been developed and implemented to perform a wide variety of functions. Most famously, blockchains can be used to store and transfer digital assets, such as cryptographic currencies. The simplicity in the creation and operation of a blockchain has resulted in a countless number of different blockchains that each track different digital assets, such as cryptographic currencies, identity tokens, security tokens, etc. However, the same characteristics that make blockchains easy to create and operate also result in difficulty in coordinating asset transfers across multiple blockchains.

Traditionally, an asset swap across multiple blockchains relies on each party to utilize a smart contract or other mechanism to hold on to their digital asset on the respective blockchain, where both smart contracts are executed once it can be confirmed that each asset has been successful transferred to the respective smart contract. Execution of the contracts results in the transfer of the digital asset to the other party on the respective blockchain. However, these methods rely on the participants themselves to create and deploy the smart contracts, which can be difficult for less sophisticated users, and can also often result in the use of smart contracts written by third parties, which can present a security risk. Additionally, the assets are held by the smart contracts themselves during the process, which can leave the assets susceptible to attack.

Thus, there is a need for a more secure method for the swapping of assets on two separate blockchains.

### SUMMARY

The present disclosure provides a description of systems and methods for processing an asset swap across two blockchains. A swap check oracle receives a transfer request from a user or smart contract on a first blockchain, which indicates the first digital asset to be transferred. The swap check oracle verifies the authenticity of the user and/or digital asset and instructs the smart contract to transfer the first digital asset to a custodial blockchain address on the first blockchain. Another swap check oracle performs the same process for a second digital asset from a second user on a second blockchain. A central processing server is notified of the successful transfer of the digital assets to the custodial addresses on both blockchains by the swap check oracles. The central processing server verifies the holding of the digital assets by the custodial addresses, and then initiates a release of the digital assets to the new parties on both of the blockchains. The result is an asset swap where oracles ensure authenticity of the parties and assets involved and a central processing server, using custodial addresses, verifies that the assets are ready to be transferred and controls the transfer of assets. As such, the asset swap can be performed more easily than traditional methods for ease of use of the users involved, and with significantly greater security by removing reliance on smart contracts and using secure, controlled custodial addresses.

A method for processing an asset swap across two blockchains includes: receiving, by a first processing system, a first transfer request including at least a first asset identifier associated with a first digital asset, one or more first identification values, and a first recipient address; authorizing, by the first processing system, transfer of the first digital asset; submitting, by the first processing system, one or more instructions to a first smart contract stored on a first blockchain, wherein submission of the one or more instructions results in execution of the first smart contract, and wherein execution of the first smart contract transfers the first digital asset to a first custodial address on the first blockchain; transmitting, by the first processing system, a first notification message indicating transfer of the first digital asset to a central processing server; receiving, by the central processing server, the first notification message from the first processing system; receiving, by the central processing server, a second notification message from a second processing system, the second notification message indicating transfer of a second digital asset to a second custodial address on a second blockchain; verifying, by the central processing server, successful transfer of the first digital asset on the first blockchain and successful transfer of the second digital asset on the second blockchain; transferring, by the central processing server, the first digital asset to the first recipient address on the first blockchain; and transferring, by the central processing server, the second digital asset to a second recipient address on the second blockchain.

A system for processing an asset swap across two blockchains includes: a first blockchain network associated with a first blockchain; a second blockchain network associated with a second blockchain; a central processing system; a first processing system; and a second processing system, wherein the first processing system receives a first transfer request including at least a first asset identifier associated with a first digital asset, one or more first identification values, and a first recipient address, authorizes transfer of the first digital asset, submits one or more instructions to a first smart contract stored on the first blockchain, wherein submission of the one or more instructions results in execution of the first smart contract, and wherein execution of the first smart contract transfers the first digital asset to a first custodial address on the first blockchain, and transmits a first notification message indicating transfer of the first digital asset to the central processing server; the central processing server receives the first notification message from the first processing system, receives a second notification message from the second processing system, the second notification message indicating transfer of a second digital asset to a second custodial address on the second blockchain, verifies successful transfer of the first digital asset on the first blockchain and successful transfer of the second digital asset on the second blockchain, transfers the first digital asset to the first recipient address on the first blockchain, and transfers the second digital asset to a second recipient address on the second blockchain.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for processing an asset swap across two blockchains in accordance with exemplary embodiments.

FIG. 2 is a block diagram illustrating a computing device in the system of FIG. 1 for processing asset swaps across two blockchains in accordance with exemplary embodiments.

FIG. 3 is a flow diagram illustrating a process for performing an asset swap across two blockchains in the system of FIG. 1 in accordance with exemplary embodiments.

FIG. 4 is a flow chart illustrating an exemplary method for processing an asset swap across two blockchains in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Processing Asset Swaps Across Blockchains

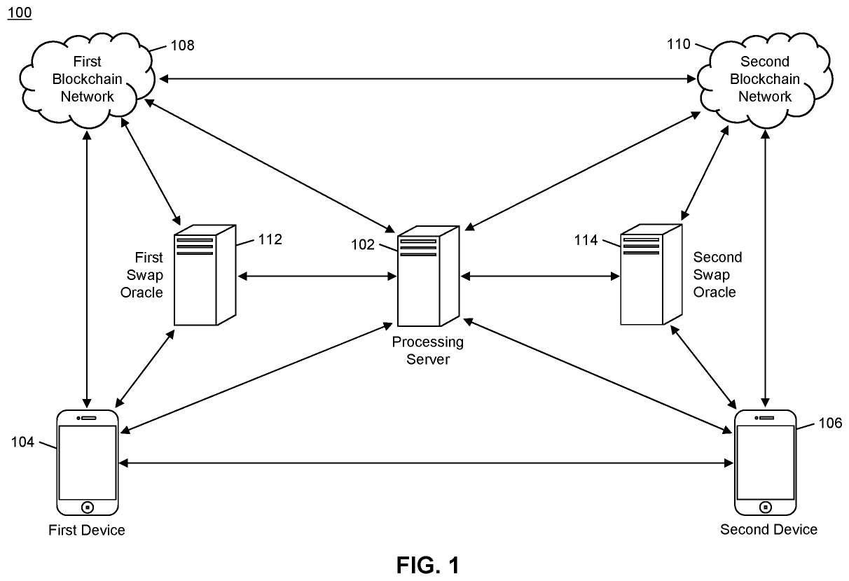

FIG. 1 illustrates a system 100 for facilitating the swap of digital assets across two blockchains through the use of swap check oracles and custodial blockchain addresses for user convenience and extra security.

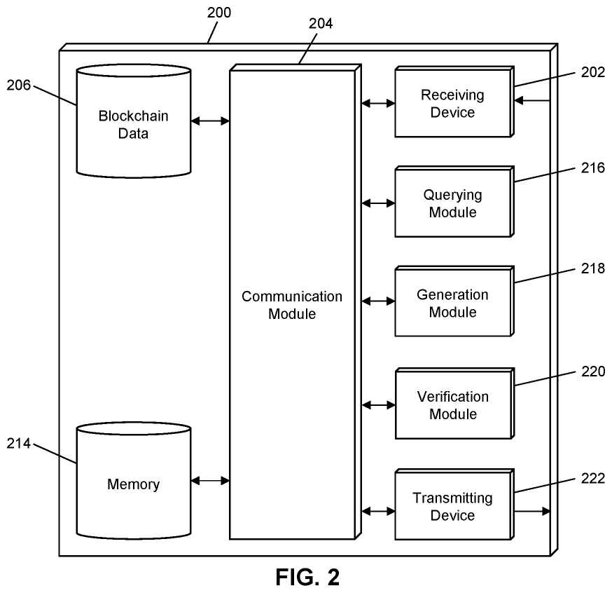

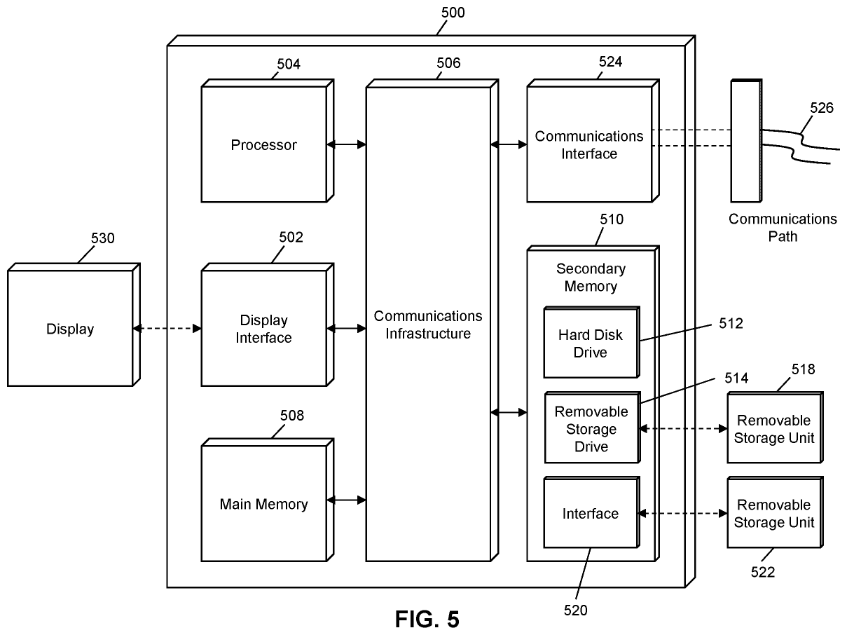

The system 100 can include a processing server 102. The processing server 102, discussed in more detail below, can be configured to operate as a central processing system to facilitate the swapping of digital assets across two blockchains. A blockchain can be managed by a blockchain network (e.g., first blockchain network 108, second blockchain network 110, etc.) included in the system 100. The blockchain network can be comprised of a plurality of blockchain nodes. Each blockchain node can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated, and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node in the blockchain network prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network using the public key of the cryptographic key pair. In some cases, the term “blockchain wallet” can refer specifically to the private key. In other cases, the term “blockchain wallet” can refer to a computing device (e.g., first device 104, second device 106, etc.) that stores the private key for use thereof in blockchain transactions. For instance, each computing device can each have their own private key for respective cryptographic key pairs, and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., first device 104) that is generated using the sender's private key, a blockchain address of the recipient of currency (e.g., second device 106) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node in the blockchain network, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other nodes in the blockchain network before being added to the blockchain and distributed to all of the blockchain nodes in the blockchain network, respectively, in traditional blockchain implementations. In cases where a blockchain data value cannot be related to a blockchain transaction, but instead the storage of other types of data, blockchain data values can still include or otherwise involve the validation of a digital signature.

In the system 100, a first device 104 can be in control of a first digital asset stored in the first blockchain network 108, where control of the first digital asset can be represented by the first digital asset being stored in a blockchain address on the blockchain associated with the first blockchain network 108 (herein referred to as the “first blockchain”) that was generated by the blockchain wallet of the first device 104. The second device 106 can be in control of a second digital asset stored in the second blockchain network 110 where, similarly, control of the second digital asset can be represented by the second digital asset being stored in a blockchain address on the blockchain associated with the second blockchain network 110 (herein referred to as the “second blockchain”) that was generated by the blockchain wallet of the second device 106. The first device 104 and second device 106 can be any type of computing device suitable for performing the functions discussed herein, such as the computing devices of FIGS. 2 and 5, which can be, for instance, a desktop computer, laptop computer, notebook computer, tablet computer, cellular phone, smart phone, smart television, wearable computing device, implantable computing device, etc. A digital asset can be any asset that is stored on a blockchain, which, in some cases, can be representative of a physical asset, such as fiat currency, a deed of land, a physical contract, etc.

The first device 104 and second device 106 (e.g., or users thereof) can agree to a swap of the first digital asset and second digital assets, where ownership of the first digital asset on the first blockchain is to be transferred to the second device 106 and ownership of the second digital asset on the second blockchain is to be transferred to the first device 104. The first device 104 can being the process for the asset swap by electronically transmitting a transfer request to a first swap oracle 112 using a suitable communication network and method. In some embodiments, the first device 104 can directly transmit the transfer request to the first swap oracle 112. In other embodiments, the transfer request can be submitted to the first swap oracle 112 by a smart contract stored in the first blockchain, which can be executed as a result of instructions by the first device 104. In some cases, the first swap oracle 112 and/or processing server 102 can provide a template for the smart contract to be used by the first device 104. The first swap oracle 112 can be any suitable type of computing device, such as those illustrated in FIGS. 2 and 5 and discussed in more detail below, which can also be a blockchain node in the first blockchain network 108. In some cases, the first swap oracle 112 can be an application program executed by the processing server 102.

The transfer request can be received by the first swap oracle 112. The transfer request can include at least an identifier associated with the first digital asset, referred to herein as an asset identifier, which can be a value that is unique to the first digital asset used in the identification thereof, such as an identification number, blockchain address, etc. The transfer request can also include data for use in verifying the ownership of the first digital asset by the first device 104, such as a digital signature generated using the private key of the blockchain wallet of the first device 104 that has ownership of the first digital asset on the first blockchain. In some cases, the transfer request can also include one or more identification data values associated with the first device 104 and/or a user thereof. In such cases, the processes discussed herein can include verification and/or authentication of the first device 104 and/or user thereof. Identification values can include any data that is suitable for use in verifying the authenticity of a computing device or user thereof, such as a media access control address, serial number, registration number, telephone number, e-mail address, name, payment account number, security code, street address, zip or postal code, etc.

The first swap oracle 112 can receive the transfer request and can verify the authenticity of the first digital asset and the first device's ownership thereof. In cases where authentication of the first device 104 and/or the user thereof is desired, the first swap oracle 112 can also initiate a process for the authentication thereof. In some embodiments, the first swap oracle 112 can perform such authentications itself. In other embodiments, the first swap oracle 112 can forward the transfer request or data included therein to the processing server 102 using a suitable communication network and method, where the processing server 102 can perform the authentications and return a result of the authentication to the first swap oracle 112. Authentication of the first digital asset and the first device's ownership thereof can be performed by validating the digital signature included in the transfer request using a public key of the first device's blockchain wallet and ensuring that the first digital asset associated with the asset identifier is stored in a blockchain address in the first blockchain controlled by the first device's blockchain wallet. Authentication of the first device 104 and/or user thereof can include the verification of the one or more identification values included in the transfer request. For instance, the user of the first device 104 can provide a name, street address, and an account number and security code for a payment card, where the processing server 102 (e.g., or first swap oracle 112, as applicable) can perform a “know your customer” (or “KYC”) process to verify the identity of the user of the first device 104 using the provided information.

If the authentication(s) performed by the first swap oracle 112 are successful, then the first swap oracle 112 can initiate the transfer of the first digital asset to a custodial address on the first blockchain, referred to herein as a “first custodial address.” The custodial address can be a blockchain address generated by a public key of a blockchain wallet associated with the first blockchain whose private key is stored or otherwise controlled by the processing server 102. The custodial address can be generated by the first swap oracle 112 directly or by the processing server 102, such as can be provided to the first swap oracle 112 with a positive authentication result by the processing server 102. The transfer of the first digital asset to the first custodial address can be performed by the first device 104, such as by the first swap oracle 112 providing the custodial address to the first device 104 and the first device 104 submitting a new blockchain transaction to a blockchain node in the first blockchain network 108 for transfer of the first digital asset to the first custodial address. In cases where a smart contract is used to submit the transfer request, the transfer of the first digital asset can be performed by the smart contract, where the first swap oracle 112 can submit the first custodial address as input to the smart contract, and the smart contract can execute and transfer the first digital asset to the first custodial address.

Once the first digital asset has been transferred to the first custodial address, the first swap oracle 112 can electronically transmit a notification message to the processing server 102 indicating the successful transfer of ownership of the first digital asset. The notification message can include the asset identifier, a transaction identifier (e.g., generated by the first swap oracle 112 and/or processing server 102 for inclusion in all messages related to the asset swap), an identification value provided by a blockchain node in the first blockchain network 108 corresponding to the blockchain data value used for the transfer of the first digital asset to the first custodial address, etc.

Before, after, or concurrently with the transfer of ownership of the first digital asset to the first custodial address, ownership of the second digital asset can be transferred to a second custodial address on the second blockchain. The second device 106 and a second swap oracle 114 can perform the same steps discussed above for the transfer of ownership of the second digital asset to a second custodial address generated by a public key of a blockchain wallet associated with the second blockchain whose private key is stored in or otherwise controlled by the processing server 102. In some cases, the transfer of ownership of the second digital asset can include the same exact steps as the transfer of ownership of the first digital asset. In other cases, the steps for the transfer of ownership of the first and second digital assets can vary. For instance, the first digital asset can be transferred via the use of a smart contract, while the second digital asset can be transferred directly by the second device 106 without the use of a smart contract. In some cases, the blockchains themselves can dictate the steps and processes used in the transfer of ownership of the respective digital assets. In some instances, the digital assets can be different types of assets. For example, the first digital asset can be a token representative of fiat currency, while the second digital asset can be cryptographic currency.

In some embodiments, the processing server 102 can verify the successful transfer of a digital asset to a respective custodial address after receipt of a notification message. The processing server 102 can, directly or with the assistance of a blockchain node in the respective blockchain network, identify the custodial address in the blockchain to determine if the digital asset associated with the asset identifier has been successfully transferred thereto. Once the processing server 102 has received a notification message from both the first swap oracle 112 indicating the transfer of ownership of the first digital asset on the first blockchain to the first custodial address and the second swap oracle 114 indicating the transfer of ownership of the second digital asset on the second blockchain to the second custodial address, and verified the transfers, if applicable, the processing server 102 can initiate the transfer of both digital assets.

The processing server 102 can submit a first blockchain transaction to a blockchain node in the first blockchain network 108 to transfer the first digital asset from the first custodial address to a blockchain wallet associated with the first blockchain of the second device 106 (e.g., to a blockchain address generated by the second device 106 and provided to the processing server 102, such as in the transfer request). The processing server 102 can also submit a second blockchain transaction to a blockchain node in the second blockchain network 110 to transfer the second digital asset from the second custodial address to a blockchain wallet associated with the second blockchain of the first device 104 (e.g., to a blockchain address generated by the second device 106 and provided to the processing server 102, such as in the transfer request). The result is that the first device 104 obtains the second digital asset on the second blockchain and the second device 106 obtains the first digital asset on the first blockchain, thereby facilitating an asset swap across the two blockchains.

In some embodiments, the first blockchain network 108 and the second blockchain network 110 can perform a settlement process, such as due to the transfer of ownership of assets as a result of asset swaps using the processes discussed above. For instance, the first blockchain and second blockchain can each be operated by or on behalf of a financial institution, where one financial institution can be required to pay fiat currency to the other financial institution as a result of the asset swaps. In another example, if an asset swap is for a digital asset that correspond to a physical object (e.g., a good, a deed of land, etc.), an entity associated with the blockchain network in which the digital asset is stored can be required to perform one or more actions with or involving the physical object, such as to record the transfer of ownership, physically deliver the physical object to the new owner, etc.

In some embodiments, authentications performed of the first device 104 and/or second device 106 and/or the users thereof can be based on a variety of criteria. For instance, the users of the first device 104 and/or second device 106 can require as level of authentication to be performed of the other user as part of the asset swap. Level of authentication can refer to an amount and/or type of data to be used in authenticating the device and/or user thereof. In another example, each blockchain network can require a level of authentication to be performed on a user of the associated blockchain that is performing an asset swap, where the level could be further based on the other blockchain involved in the asset swap. In yet another example, the level of authentication can be based on geographic location, where the data used in the authentication can be dictated by the geographic location of the device, the user thereof, the blockchain network, and/or the swap oracle.

The result of the methods and systems discussed herein is the swap of assets across two blockchains that is easier for involved users while having greater security than using traditional methods. The use of swap oracles 112 and 114 ensure that users, devices, and/or digital assets can be authenticated at a suitable level to provide sufficient security as desired by all parties involved, while the use of custodial addresses and the processing server 102 provide for significantly greater security than traditional methods to ensure that smart contracts cannot be attacked to steal digital assets and prevent nefarious actions by either party involved in the swap.

### Computing Device

FIG. 2 illustrates an embodiment of a computing device 200. It will be apparent to persons having skill in the relevant art that the embodiment of the computing device 200 illustrated in FIG. 2 is provided as illustration only and cannot be exhaustive to all possible configurations of the computing device 200 suitable for performing the functions as discussed herein. For example, the computer system 500 illustrated in FIG. 5 and discussed in more detail below can be a suitable configuration of the processing server 102. In some cases, components of the system 100, such as the processing server 102, first device 104, second device 106, first swap oracle 112, second swap oracle 114, or blockchain nodes of the first blockchain network 108 and/or second blockchain network 110 can include the components illustrated in FIG. 2 and discussed below.

The computing device 200 can include a receiving device 202. The receiving device 202 can be configured to receive data over one or more networks via one or more network protocols. In some instances, the receiving device 202 can be configured to receive data from processing servers 102, first devices 104, second devices 106, first swap oracles 112, second swap oracles 114, blockchain nodes, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by processing servers 102 that are superimposed or otherwise encoded with blockchain transactions, notification of successful asset transfers, authentication results, custodial addresses, etc. The receiving device 202 can also be configured to receive data signals electronically transmitted by first devices 104 and/or second devices 106, which can be superimposed or otherwise encoded with transfer requests, blockchain addresses, asset identifiers, identification values, blockchain transactions, etc. The receiving device 202 can also configured to receive data signals electronically transmitted by first swap oracles 112 and/or second swap oracles 114 that can be superimposed or otherwise encoded with transfer requests, authentication results, custodial addresses, smart contract instructions, notification messages, etc. The receiving device 202 can also be configured to receive data signals electronically transmitted by blockchain nodes of the first blockchain network 108 and/or second blockchain network 110, which can be superimposed or otherwise encoded with blockchain data values, identifiers, digital signatures, etc.

The computing device 200 can also include a communication module 204. The communication module 204 can be configured to transmit data between modules, engines, databases, memories, and other components of the computing device 200 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the computing device 200 and external components of the computing device 200, such as externally connected databases, display devices, input devices, etc. The computing device 200 can also include a processing device. The processing device can be configured to perform the functions of the computing device 200 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, verification module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The computing device 200 can also include blockchain data 206, which can be stored in a memory 214 of the computing device 200 or stored in a separate area within the computing device 200 or accessible thereby. The blockchain data 206 can include a blockchain, which can be comprised of a plurality of blocks and be associated with the first blockchain network 108 or second blockchain network 110. In some cases, the blockchain data 206 can further include any other data associated with the blockchain and management and performance thereof, such as block generation algorithms, digital signature generation and confirmation algorithms, communication data for blockchain nodes, smart contracts, cryptographic key pairs, public keys, etc.

The computing device 200 can also include a memory 214. The memory 214 can be configured to store data for use by the computing device 200 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the computing device 200 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, authentication level data, authentication rules, message formatting rules, smart contract instructions, rules associated with different types of digital assets, etc.

The computing device 200 can include a querying module 216. The querying module 216 can be configured to execute queries on databases to identify information. The querying module 216 can receive one or more data values or query strings, and can execute a query string based thereon on an indicated database, such as the memory 214 of the computing device 200 to identify information stored therein. The querying module 216 can then output the identified information to an appropriate engine or module of the computing device 200 as necessary. The querying module 216 can, for example, execute a query on the memory 214 to identify a public key of a blockchain wallet associated the first blockchain to be used in the generation of the first custodial address.

The computing device 200 can also include a generation module 218. The generation module 218 can be configured to generate data for use by the computing device 200 in performing the functions discussed herein. The generation module 218 can receive instructions as input, can generate data based on the instructions, and can output the generated data to one or more modules of the computing device 200. For example, the generation module 218 can be configured to generate data messages, notification messages, blockchain addresses, blockchain transactions, asset transfer instructions, transfer requests, identification values, authentication result messages, etc.

The computing device 200 can also include a verification module 220. The verification module 220 can be configured to perform verifications and authentications for the computing device 200 as part of the functions discussed herein. The verification module 220 can receive instructions as input, which can also include data to be used in performing a verification or authentication, can perform a verification or authentication as requested, and can output a result of the verification or authentication to another module or engine of the computing device 200. The verification module 220 can, for example, be configured to verify the ownership of a digital asset whose transfer is requested as part of an asset swap, to authenticate a device or a user thereof, to verify the successful transfer of a digital asset to a custodial address, etc.

The computing device 200 can also include a transmitting device 222. The transmitting device 222 can be configured to transmit data over one or more networks via one or more network protocols. In some instances, the transmitting device 222 can be configured to transmit data to processing servers 102, first devices 104, second devices 106, first swap oracles 112, second swap oracles 114, blockchain nodes, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to processing servers 102 that are superimposed or otherwise encoded with blockchain transactions, notification messages, authentication results, blockchain data values, transfer requests, blockchain addresses, etc. The transmitting device 222 can be configured to electronically transmit data signals to first devices 104 and/or second devices 106, which can be superimposed or otherwise encoded with blockchain addresses, identification value requests, asset transfer instructions, notification messages, etc. The transmitting device 222 can be configured to electronically transmit data signals to first swap oracles 112 and/or second swap oracles 114 that can be superimposed or otherwise encoded with transfer requests, authentication results, custodial addresses, notification messages, identification values, asset identifiers, blockchain data values, etc. The transmitting device 222 can be configured to electronically transmit data signals to blockchain nodes of the first blockchain network 108 and/or second blockchain network 110, which can be superimposed or otherwise encoded with blockchain data values, digital signatures, blockchain transactions, requests for blockchain data, cryptographic keys, etc.

### Process for Performing an Asset Swap on Two Blockchains

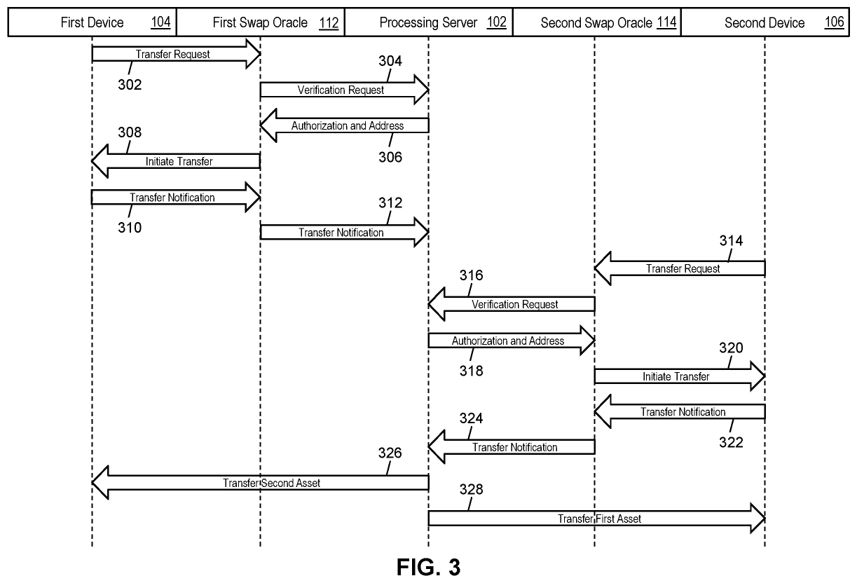

FIG. 3 illustrates a process for performing an asset swap of digital assets stored in two different blockchains in the system 100.

In step 302, the first device 104 can electronically transmit (e.g., via a transmitting device 222) a transfer request to the first swap oracle 112 using a suitable communication network and method. The transfer request can include an asset identifier associated with the first digital asset on the first blockchain, recipient blockchain address for the first device 104 on the second blockchain, and one or more identification values. In step 304, the first swap oracle 112 can electronically transmit (e.g., via a transmitting device 222) a verification request to the processing server 102 using a suitable communication network and method. The verification request can include at least the one or more identification values. The processing server 102 can (e.g., via a verification module 220) perform one or more authentications using the received one or more identification values. If the authentication(s) are successful, the processing server 102 can (e.g., via a generation module 218) generate a first custodial address using a blockchain wallet associated with the first blockchain and, in step 306, electronically transmit (e.g., via a transmitting device 222) a notification indicating the successful authentication(s) and the first custodial address back to the first swap oracle 112.

In step 308, the first swap oracle 112 can electronically transmit (e.g., via a transmitting device 222) an instruction message to the first device 104 that includes the first custodial address and instructs the first device 104 to transfer the first digital asset to the first custodial address on the first blockchain. The first device 104 can receive (e.g., via a receiving device 202) the message and can submit a new blockchain transaction to a blockchain node in the first blockchain network 108 to transfer the first digital asset to the first custodial address using traditional methods. The blockchain node can return a transaction identifier or other unique value regarding the blockchain data value for the new blockchain transaction to the first device 104 (e.g., received via a receiving device 202). In step 310, the first device 104 can electronically transmit (e.g., via a transmitting device 222) a notification of the transfer of the first digital asset that includes the transaction identifier or other unique value to the first swap oracle 112. In step 312, the first swap oracle 112 can forward (e.g., via a transmitting device 222) the transfer notification to the processing server 102 using a suitable communication network and method.

In step 314, the second device 106 can electronically transmit (e.g., via a transmitting device 222) a transfer request to the second swap oracle 114 using a suitable communication network and method. The transfer request can include an asset identifier associated with the second digital asset on the second blockchain, recipient blockchain address for the second device 106 on the first blockchain, and one or more identification values. In step 316, the second swap oracle 114 can electronically transmit (e.g., via a transmitting device 222) a verification request to the processing server 102 using a suitable communication network and method. The verification request can include at least the one or more identification values. The processing server 102 can (e.g., via a verification module 220) perform one or more authentications using the received one or more identification values. If the authentication(s) are successful, the processing server 102 can (e.g., via a generation module 218) generate a second custodial address using a blockchain wallet associated with the second blockchain and, in step 318, electronically transmit (e.g., via a transmitting device 222) a notification indicating the successful authentication(s) and the second custodial address back to the second swap oracle 114.

In step 320, the second swap oracle 114 can electronically transmit (e.g., via a transmitting device 222) an instruction message to the second device 106 that includes the second custodial address and instructs the second device 106 to transfer the second digital asset to the second custodial address on the second blockchain. The second device 106 can receive (e.g., via a receiving device 202) the message and can submit a new blockchain transaction to a blockchain node in the second blockchain network 110 to transfer the second digital asset to the second custodial address using traditional methods. The blockchain node can return a transaction identifier or other unique value regarding the blockchain data value for the new blockchain transaction to the second device 106 (e.g., received via a receiving device 202). In step 322, the second device 106 can electronically transmit (e.g., via a transmitting device 222) a notification of the transfer of the second digital asset that includes the transaction identifier or other unique value to the second swap oracle 114. In step 324, the second swap oracle 114 can forward (e.g., via a transmitting device 222) the transfer notification to the processing server 102 using a suitable communication network and method. Steps 314 through 324 can be performed prior to steps 302 through 312, after steps 302 through 312, or concurrently while steps 302 through 312 are being performed.

In step 326, the processing server 102 can submit a new blockchain transaction to a blockchain node in the second blockchain network 110 to transfer the second digital asset to the recipient blockchain address for the first device 104 on the second blockchain. The result is that the first device 104 obtains ownership of the second digital asset on the second blockchain. In step 328, the processing server 102 can submit a new blockchain transaction to a blockchain node in the first blockchain network 108 to transfer the first digital asset to the recipient blockchain address for the second device 106 on the first blockchain. The result is that the second device 106 obtains ownership of the first digital asset on the first blockchain.

### Exemplary Method for Processing an Asset Swap Across Two Blockchains

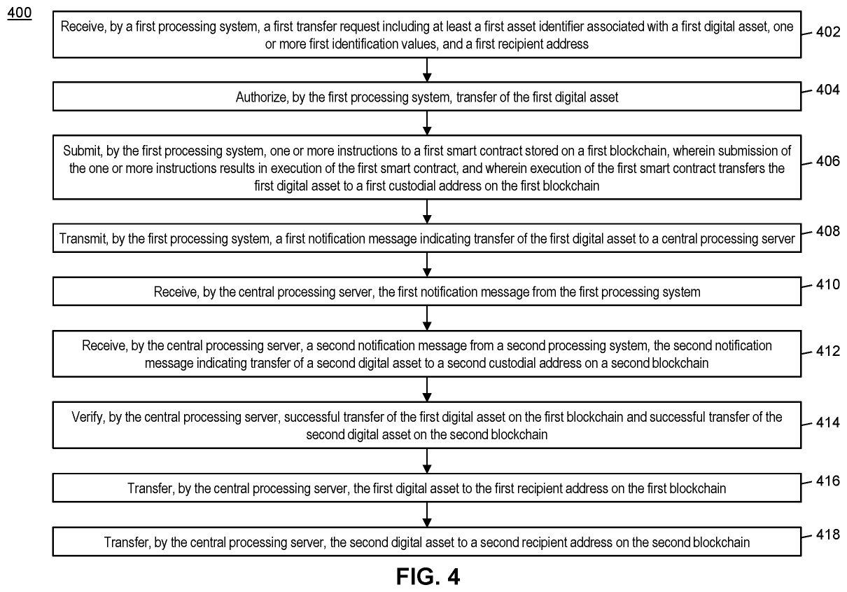

FIG. 4 illustrates a method 400 for the processing of an asset swap across two blockchains through the use of multiple processing systems, a central processing server, and custodial blockchain addresses.

In step 402, a first transfer request can be received (e.g., via a receiving device 202) by a first processing system (e.g., first swap oracle 112), the transfer request including at least a first asset identifier associated with a first digital asset, one or more first identification values, and a first recipient address. In step 404, the first processing system can authorize (e.g., via a verification module 220) transfer of the first digital asset. In step 406, one or more instructions can be submitted (e.g., via a transmitting device 222) by the first processing system (e.g., first swap oracle 112) to a first smart contract stored on a first blockchain, wherein submission of the one or more instructions results in execution of the first smart contract, and wherein execution of the first smart contract transfers the first digital asset to a first custodial address on the first blockchain.

In step 408, a first notification message indicating transfer of the first digital asset can be transmitted (e.g., via a transmitting device 222) by the first processing system to a central processing server (e.g., processing server 102). In step 410, the first notification message can be received (e.g., via a receiving device 202) by the central processing server from the first processing system. In step 412, the central processing server can receive (e.g., via a receiving device 202) a second notification message from a second processing system (e.g., second swap oracle 114), the second notification message indicating transfer of a second digital asset to a second custodial address on a second blockchain.

In step 414, the central processing server can verify (e.g., via a verification module 220) successful transfer of the first digital asset on the first blockchain and successful transfer of the second digital asset on the second blockchain. In step 416, the first digital asset can be transferred by the central processing server to the first recipient address on the first blockchain. In step 418, the second digital asset can be transferred by the central processing server to a second recipient address on the second blockchain.

In one embodiment, the first processing system and the second processing system can be a single computing device (e.g., a computing device 200). In some embodiments, the first processing system and the second processing system can application programs executed by the central processing server. In one embodiment, the first processing system can be a first blockchain node in a first blockchain network (e.g., first blockchain network 108) associated with the first blockchain, and the second processing system can be a second blockchain node in a second blockchain network (e.g., second blockchain network 110) associated with the second blockchain. In some embodiments, authorizing transfer of the first digital asset can include generating the first custodial address.

In one embodiment, authorizing transfer of the first digital asset can comprise: transmitting, by the first processing system (e.g., via a transmitting device 222), at least the one or more identification values to the central processing server; verifying, by the central processing server (e.g., via a verification module 220), the one or more identification values; generating, by the central processing server (e.g., via a generation module 218), the first custodial address; and receiving, by the first processing system (e.g., via a receiving device 202), a message indicating successful verification of the one or more identification values from the central processing server, the message further including the first custodial address. In some embodiments, the first transfer request can be received from the first smart contract. In one embodiment, authorizing transfer of the first digital asset can include verifying (e.g., via a verification module 220) authenticity of the first digital asset.

### Computer System Architecture

FIG. 5 illustrates a computer system 500 in which embodiments of the present disclosure, or portions thereof, can be implemented as computer-readable code. For example, the processing server 102, first device 104, second device 106, first swap oracle 112, and second swap oracle 114 of FIG. 1 and the computing device 200 of FIG. 2 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for processing an asset swap across two blockchains. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for processing an asset swap across two blockchains, comprising:
receiving, by a first processing system, a first transfer request including at least a first asset identifier associated with a first digital asset, one or more first identification values, and a first recipient address;
authorizing, by the first processing system, transfer of the first digital asset;
submitting, by the first processing system, one or more instructions to a first smart contract stored on a first blockchain, wherein submission of the one or more instructions results in execution of the first smart contract, and wherein execution of the first smart contract transfers the first digital asset to a first custodial address on the first blockchain;
transmitting, by the first processing system, a first notification message indicating transfer of the first digital asset to a central processing server;
receiving, by the central processing server, the first notification message from the first processing system;
receiving, by the central processing server, a second notification message from a second processing system, the second notification message indicating transfer of a second digital asset to a second custodial address on a second blockchain;
verifying, by the central processing server, successful transfer of the first digital asset on the first blockchain and successful transfer of the second digital asset on the second blockchain;
transferring, by the central processing server, the first digital asset to the first recipient address on the first blockchain; and
transferring, by the central processing server, the second digital asset to a second recipient address on the second blockchain.

2. The method of claim 1, wherein the first processing system and the second processing system are a single computing device.

3. The method of claim 1, wherein the first processing system and the second processing system are application programs executed by the central processing server.

4. The method of claim 1, wherein
the first processing system is a first blockchain node in a first blockchain network associated with the first blockchain, and
the second processing system is a second blockchain node in a second blockchain network associated with the second blockchain.

5. The method of claim 1, wherein authorizing transfer of the first digital asset includes generating the first custodial address.

6. The method of claim 1, wherein authorizing transfer of the first digital asset comprises:
transmitting, by the first processing system, at least the one or more identification values to the central processing server;
verifying, by the central processing server, the one or more identification values;
generating, by the central processing server, the first custodial address; and
receiving, by the first processing system, a message indicating successful verification of the one or more identification values from the central processing server, the message further including the first custodial address.

7. The method of claim 1, wherein the first transfer request is received from the first smart contract.

8. The method of claim 1, wherein authorizing transfer of the first digital asset includes verifying authenticity of the first digital asset.

9. A system for processing an asset swap across two blockchains, comprising:
a first blockchain network associated with a first blockchain;
a second blockchain network associated with a second blockchain;
a central processing system;
a first processing system; and
a second processing system, wherein
the first processing system
receives a first transfer request including at least a first asset identifier associated with a first digital asset, one or more first identification values, and a first recipient address,
authorizes transfer of the first digital asset,
submits one or more instructions to a first smart contract stored on the first blockchain, wherein submission of the one or more instructions results in execution of the first smart contract, and wherein execution of the first smart contract transfers the first digital asset to a first custodial address on the first blockchain, and
transmits a first notification message indicating transfer of the first digital asset to the central processing server;
the central processing server
receives the first notification message from the first processing system,
receives a second notification message from the second processing system, the second notification message indicating transfer of a second digital asset to a second custodial address on the second blockchain,
verifies successful transfer of the first digital asset on the first blockchain and successful transfer of the second digital asset on the second blockchain,
transfers the first digital asset to the first recipient address on the first blockchain, and
transfers the second digital asset to a second recipient address on the second blockchain.

10. The system of claim 9, wherein the first processing system and the second processing system are a single computing device.

11. The system of claim 9, wherein the first processing system and the second processing system are application programs executed by the central processing server.

12. The system of claim 9, wherein
the first processing system is a first blockchain node in the first blockchain network, and
the second processing system is a second blockchain node in the second blockchain network.

13. The system of claim 9, wherein authorizing transfer of the first digital asset includes generating the first custodial address.

14. The system of claim 9, wherein authorizing transfer of the first digital asset comprises:
transmitting, by the first processing system, at least the one or more identification values to the central processing server;
verifying, by the central processing server, the one or more identification values;
generating, by the central processing server, the first custodial address; and
receiving, by the first processing system, a message indicating successful verification of the one or more identification values from the central processing server, the message further including the first custodial address.

15. The system of claim 9, wherein the first transfer request is received from the first smart contract.

16. The system of claim 9, wherein authorizing transfer of the first digital asset includes verifying authenticity of the first digital asset.
